(19) United States
(12) Patent Application Publication
(10) Pub. No.: US 2008/0130337 A1
(43) Pub. Date: Jun. 5, 2008

(54) Voltage Generating Circuit

(75) Inventor: Yukio Takahashi, Kiryu-shi (JP)

Correspondence Address: SoCAL IP LAW GROUP LLP, 310 N. WESTLAKE BLVD. STE 120, WESTLAKE VILLAGE, CA, 91362, US

(73) Assignees: Sanyo Electric Co., Ltd., Osaka (JP); Sanyo Semiconductor Co., Ltd., Ora-gun (JP)

(21) Appl. No.: 11/866,257

(22) Filed: Oct. 2, 2007

(30) Foreign Application Priority Data
Oct. 11, 2006 (JP) 2006-277698

(51) Int. Cl. H02M 7/06

(52) U.S. Cl. 363/126

(57) ABSTRACT

A voltage generating circuit for generating a DC voltage at both ends of a series capacitor based on an AC voltage generated from an AC power supply with one end thereof connected to a coil, the series capacitor including a first capacitor and a second capacitor with a series connecting point thereof connected to the other end of the AC power supply, the voltage generating circuit comprising: a first transistor connected to the one end of the AC power supply via the coil; a second transistor connected to the other end of the AC power supply; a first diode connected in parallel to the second transistor in a reverse direction, and in series to the first transistor in a forward direction; a second diode connected in parallel to the first transistor in a reverse direction, and in series to the second transistor in a forward direction; a third diode connected between the one end of the AC power supply via the coil and one end of the series capacitor, in a forward direction from the AC power supply to the one end of the series capacitor; and a fourth diode connected between the one end of the AC power supply via the coil and the other end of the series capacitor, in a reverse direction from the AC power supply to the other end of the series capacitor.

### CROSS-REFERENCE TO RELATED APPLICATION

This application claims the benefit of priority to Japanese Patent Application No. 2006-277698, filed Oct. 11, 2006, of which full contents are incorporated herein by reference.

### BACKGROUND OF THE INVENTION

1. Field of the Invention

The present invention relates to a voltage generating circuit.

2. Description of the Related Art

A voltage generating circuit has recently become available, which generates a direct-current (DC) voltage based on the alternating-current (AC) voltage of an AC power supply. Such a voltage generating circuit is used in a power supply circuit, etc. for applying a DC voltage based on an AC voltage of an AC power supply to various electric equipments (e.g. air conditioner), for example. A voltage generating circuit 101 will be described hereinafter with reference to FIGS. 8 to 10. FIG. 8 is a circuit diagram for showing an entire configuration of a power supply circuit 100 including the voltage generating circuit 101. FIG. 9 is a diagram for showing a path of a current flowing from one end of an AC power supply 120 in the power supply circuit 100. FIG. 10 is a diagram for showing a path of a current flowing from the other end of the AC power supply 120 in the power supply circuit 100.

The power supply circuit 100 includes a reactor 102, a voltage generating circuit 101, resistors 104 and 105, and a series capacitor for smoothing including capacitors 103A and 103B. The voltage generating circuit 101 further includes diodes 106A to 106D bridge-connected, diodes 108 and 109, and an npn-type transistor 107. The capacitors 103A and 103B includes, at least, a charge capacity large enough for charging at a maximum AC voltage. The npn-type transistor 107 is controlled as to ON and OFF in order to suppress harmonics and improve the power factor, etc. More specifically, the npn-type transistor 107 is controlled as to ON and OFF based on a control signal having alternately high level and low level with a repetition frequency higher than that of the AC voltage, according to the magnitude of the current detected at the resistor 105. For example, the frequency of the control signal is a frequency (equal to or higher than 100 Hz/120 Hz) at which ON/OFF control is enabled at least once in approximately ¼ cycle from the zero cross point of the AC voltage at a frequency of 50 Hz/60 Hz. There are known ON/OFF control methods such as: the method of controlling ON/OFF once in a half cycle of the AC voltage; and the method of controlling ON/OFF across entire range of each cycle of the AC voltage by setting with a carrier frequency between 20 kHz to 25 KHz, at which suppression of switching loss is enabled and audio frequency band is avoided. Therefore, the current flowing into the power supply circuit 100 becomes analogous in waveform to a sine-wave AC voltage so that the harmonics are suppressed and power factor is improved.

Since the potential of the one end of the AC power supply 120, which is connected to the reactor 102, becomes higher than that of the other end thereof, when the npn-type transistor 107 is ON on the basis of the control signal, the current flows out from the one end of the AC power supply 120 into the other end thereof along the path shown with a single-dotted line in FIG. 9, through the reactor 102, the diode 106A, the npn-type transistor 107, the resistor 105 and the diode 106C. At this time, the energy is charged in the reactor 102, and the current flowing from the one end of the AC power supply 120 is rectified by the rectifying function of the diodes 106A and 106C. When the npn-type transistor 107 is OFF on the basis of the control signal, the current flows from the one end of the AC power supply 120 into the other end thereof along the path shown with a double-dotted line in FIG. 9, via the reactor 102, the diode 108 and the capacitor 103A. At this time, the current flowing from the one end of the AC power supply 120 is rectified by the rectifying function of the diode 108, and smoothed by the capacitor 103A. The capacitor 103A is charged with the AC component. Furthermore, since the energy charged in the reactor 102 is output to one end of the series capacitor through the diode 108, the DC voltage generated between the one end of the series capacitor and the series connection point becomes greater than the voltage generated between both ends of capacitor 103A, which is charged with the AC component.

On the other hand, since the potential of the other end of the AC power supply 120 becomes higher than that of the one end thereof, when the npn-type transistor 107 is ON on the basis of the control signal, the current flows out from the other end of the AC power supply 120 into the one end thereof along the path shown with a single-dotted line in FIG. 10, through the diode 106B, the npn-type transistor 107, the resistor 105, the diode 106D and the reactor 102. At this time, the current flowing from the other end of the AC power supply 120 is rectified by the rectifying function of the diodes 106B and 106D, and the energy is charged in the reactor 102. When the npn-type transistor 107 is OFF on the basis of the control signal, the current flows from the other end of the AC power supply 120 into the one end thereof, along the path shown with a double-dotted line in FIG. 10, through the capacitor 103B, the diode 109 and the reactor 102. At this time, the current flowing from the other end of the AC power supply 120 is smoothed by the capacitor 103B, rectified by the rectifying function of the diode 109, and the capacitor 103B is charged with the AC component. Furthermore, since the energy charged in the reactor 102 is output to the series connection point of the series capacitor through the AC power supply 120, the DC voltage generated between the series connection point and the other end of the series capacitor becomes greater than the voltage generated between both ends of capacitor 103B, which is charged with the AC component.

As a result of the above, the charge voltage of the capacitors 103A and 103B has reached the substantially maximum AC voltage, and the DC voltage, which is substantially more than twice the maximum AC voltage, is generated between both ends of the series capacitor, due to the charge voltage of the capacitors 103A and 103B and the energy from the reactor 102. The power supply circuit 100 applies this DC voltage as an output voltage to the various electric equipments. As a result, the DC voltage is applied as a power supply voltage to the various electric equipments so that the various electric equipments can be driven.

(See Japanese Patent Application Laid-open Numbers 2001-286149 and 2004-129387.)

However, in such a voltage generating circuit 101, there are eight intermediary elements in the paths of the currents flowing out from the one end and the other end of the AC power supply 120. In other words, in the path of the current flowing out from the one end of the AC power supply, there are the intermediary elements including the diode 106A, the diode 106C and the npn-type transistor 107 when the npn-type transistor 107 is ON (single-dotted line in FIG. 9); and there is the intermediary element including the diode 108 when the npn-type transistor 107 is OFF (double-dotted line in FIG. 9). In the path of the current flowing out from the other end of the AC power supply, there are the intermediary elements including the diode 106B, the diode 106D and the npn-type transistor 107 when the npn-type transistor 107 is ON (single-dotted line in FIG. 10); and there is the intermediary element including the diode 109 when the npn-type transistor 107 is OFF (double-dotted line in FIG. 10).

Therefore, in the voltage generating circuit 101, the power is consumed since the currents flows through the eight circuit elements, so that the DC voltage generated between the two ends of the series capacitor based on the AC voltage drops in level; that is, the power factor of the voltage generating circuit 101 is decreased. The voltage generating circuit 101 includes eight circuit elements, which may disturb the reduction of the cost and size according to the voltage generating circuit 101. That is, in the voltage generating circuit 101 for generating the DC voltage based on the AC voltage, it is preferable to minimize the number of circuit elements on the paths of the currents flowing from the one and the other ends of the AC power supply 120.

### SUMMARY OF THE INVENTION

A voltage generating circuit according to an aspect of the present invention, for generating a DC voltage at both ends of a series capacitor based on an AC voltage generated from an AC power supply with one end thereof connected to a coil, the series capacitor including a first capacitor and a second capacitor with a series connecting point thereof connected to the other end of the AC power supply, comprises: a first transistor connected to the one end of the AC power supply via the coil; a second transistor connected to the other end of the AC power supply; a first diode connected in parallel to the second transistor in a reverse direction, and in series to the first transistor in a forward direction; a second diode connected in parallel to the first transistor in a reverse direction, and in series to the second transistor in a forward direction; a third diode connected between the one end of the AC power supply via the coil and one end of the series capacitor, in a forward direction from the AC power supply to the one end of the series capacitor; and a fourth diode connected between the one end of the AC power supply via the coil and the other end of the series capacitor, in a reverse direction from the AC power supply to the other end of the series capacitor, a current from the one end of the AC power supply flowing through the coil, the first transistor and the first diode into the other end of the AC power supply when the first transistor is ON, and the current flowing through the coil, the third diode and the first capacitor into the other end of the AC power supply when the first transistor is OFF; and a current from the other end of the AC power supply flowing through the second transistor, the second diode and the coil into the one end of the AC power supply when the second transistor is ON, and the current flowing through the second capacitor, the fourth diode and the coil into the one end of the AC power supply when the second transistor is OFF.

Other features of the present invention will become apparent from descriptions of this specification and of the accompanying drawings.

### BRIEF DESCRIPTION OF THE DRAWINGS

For more thorough understanding of the present invention and advantages thereof, the following description should be read in conjunction with the accompanying drawings, in which:

FIG. 1 is a circuit diagram showing an entire configuration of a voltage generating circuit according to an embodiment of the present invention;

FIG. 2A is a diagram showing another connection example of the resistor 3 shown in FIG. 1;

FIG. 2B is a diagram showing another connection example of the resistor 3 shown in FIG. 1

FIG. 3 is a circuit block diagram showing an overall configuration of a power supply circuit including a voltage generating circuit according to an embodiment of the present invention;

FIG. 4 is a diagram showing a path of a current in a voltage generating circuit according to an embodiment of the present invention;

FIG. 5 is a diagram showing a path of a current in a voltage generating circuit according to an embodiment of the present invention;

FIG. 6A is a table showing efficiency and loss of a voltage generating circuit shown in FIGS. 8 to 10;

FIG. 6B is a table showing efficiency and loss in the voltage generating circuit according to an embodiment of the present invention;

FIG. 7 is a plot showing efficiency and loss of a voltage generating circuit shown in FIGS. 8 to 10 and those of a voltage generating circuit according to an embodiment of the present invention;

FIG. 8 is a circuit diagram showing an overall configuration of a power supply circuit including a voltage generating circuit;

FIG. 9 is a diagram showing a path of a current in a voltage generating circuit; and

FIG. 10 is a diagram showing a path of another current in a voltage generating circuit.

### DETAILED DESCRIPTION OF THE INVENTION

At least the following details will become apparent from descriptions of this specification and of the accompanying drawings.

### ===Overall Configuration of a Voltage Generating Circuit According to an Exemplary Embodiment of the Present Invention ===

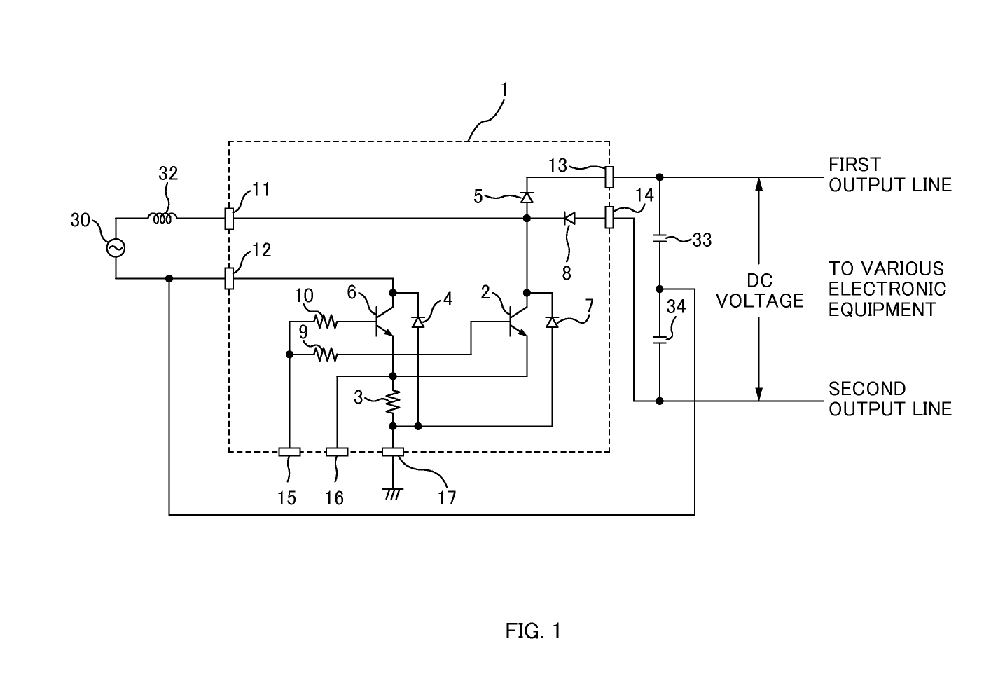

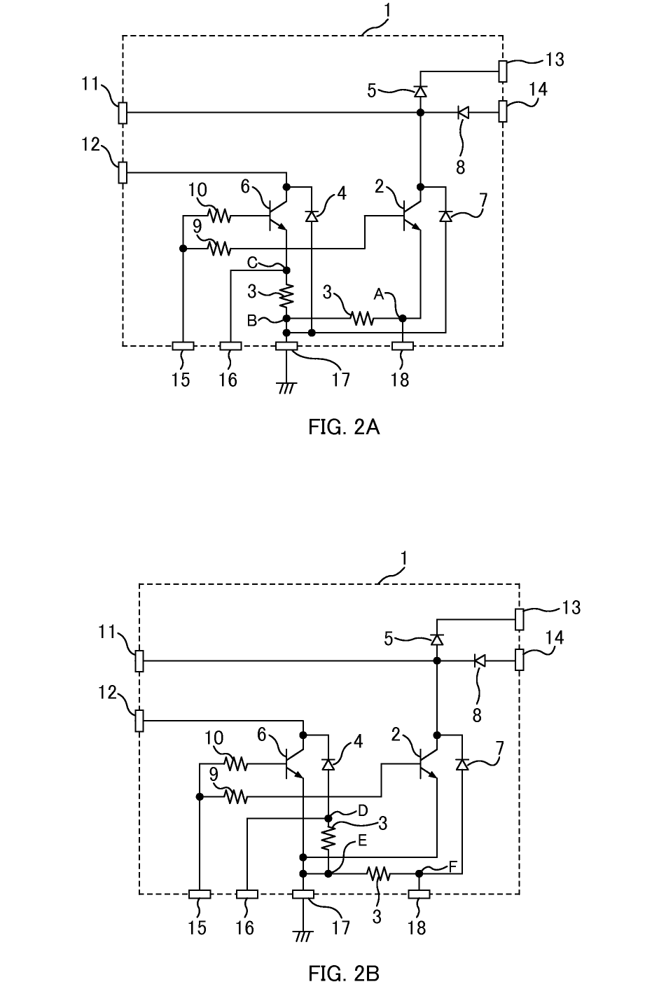

An overall configuration of a voltage generating circuit 1 according to an embodiment of the present invention will be described hereinafter with reference to FIGS. 1 and 2. FIG. 1 is a diagram showing an example of an entire configuration of the voltage generating circuit 1 according to the embodiment of the present invention. FIGS. 2A and 2B are diagrams showing other connection examples of the resistor 3 shown in FIG. 1.

The voltage generating circuit 1 includes an npn-type transistor 2 (first transistor), an npn-type transistor 6 (second transistor), resistors 3, 9 and 10, a diode 4 (first diode), a diode 5 (third diode), a diode 7 (second diode), a diode 8 (fourth diode), input-output terminals 11 and 12, an output terminal 13, an input terminal 14, and connecting terminals 15 to 17. In the present embodiment, the voltage generating circuit 1 is described assuming that the voltage generating circuit 1 is used for a power supply circuit for applying a DC voltage based on an AC voltage to the various electric equipments. The voltage generating circuit 1 is also so described as to be integrated on an insulated metal substrate, for example.

In order to suppress harmonics and to improve power factor etc., the npn-type transistor 2 is controlled as to ON and OFF based on a control signal having alternately high level and low level with a repetition frequency higher than that of the AC voltage with a repetition of, according to the magnitude of the current detected at the resistor 3. This control signal will be described later. The npn-type transistor 2 is constituted by an Insulated Gate Bipolar Transistor (IGBT), for example, where the base thereof is connected to one end of the resistor 9, the collector thereof is connected to the input-output terminal 11, and the emitter thereof is connected to the one end of the resistor 3. The npn-type transistor 2 is turned ON based on a high-level control signal that is input to the connecting terminal 15 via the resistor 9, and supplies to the resistor 3 an emitter current according to the collector current supplied to the input-output terminal 11 and the base current. Since the base current is sufficiently smaller than the collector current, it is assumed to be described that a current supplied to the input-output terminal 11 is supplied to the resistor 3 when the npn-type transistor 2 is ON. The npn-type transistor 2 is turned OFF based on a low-level control signal that is input to the connecting terminal 15 via the resistor 9. In an embodiment according to the present invention, the IGBTs (npn-type transistors 2 and 6) are used, however, which is not limitation; a pnp-type transistor, or, for example, MOSFET (Metal Oxide Semiconductor Field Effect Transistor), etc. may be used.

In order to suppress harmonics and to improve power factor etc., the npn-type transistor 6 is controlled as to ON and OFF based on a control signal having alternately high level and low level with a repetition frequency higher than that of the AC voltage, according to the magnitude of the current detected at the resistor 3. The control signal will be described later. The npn-type transistor 6 is constituted by an Insulated Gate Bipolar Transistor (IGBT), as in the case as with the npn-type transistor 2, where the base thereof is connected to one end of the resistor 10, the collector thereof is connected to the input-output terminal 12, and the emitter thereof is connected to the one end of the resistor 3. The npn-type transistor 6 is turned ON based on a high-level control signal that is input to the connecting terminal 15 via the resistor 10, and supplies to the resistor 3 the emitter current according to the collector current supplied to the input-output terminal 12 and the base current. Since the base current is sufficiently smaller than the collector current, it is assumed to be described that a current supplied to the input-output terminal 12 is supplied to the resistor 3 when the npn-type transistor 6 is ON. The npn-type transistor 6 is turned OFF based on a low-level control signal that is input to the connecting terminal 15 via the resistor 10.

The one end of the resistor 9 is connected to a base of the npn-type transistor 2, and the other end thereof is connected to the connecting terminal 15 to which the other end of the resistor 10 is commonly connected. A one end of the resistor 10 is connected to the base of the npn-type transistor 6, and the other end thereof is connected to the connecting terminal 15 to which the other end of the resistor 9. In other words, a common signal line is used for sending the control signals to the bases of the npn-type transistors 2 and 6.

The connection terminal 17 is grounded.

The resistor 3 is a shunt resistor that is provided to detect the current flowing from the one and the other end of an AC power supply 30, when the npn-transistors 2 and 6 are ON, thorough the npn-transistors 2 and 6. Therefore, the resistor 3 is series-connected to the npn-type transistor 2 and the diode 4, and to the npn-type transistor 6 and the diode 4, as well as to the connecting terminal 17. The resistor 3 not only is connected as shown in the FIG. 1, but also may be connected between points A and B, for example. It is also possible that, by providing two resistors 3, as shown in FIG. 2A, one resistor 3 (first resistor) is connected between the connection point A, provided to the emitter-side of the npn-type transistor 2, and the connection point B, connected to the connection terminal 17; and the other resistor 3 (second resistor) is connected between a connection point C, provided to the emitter-side of the npn-type transistor 6, and the connection point B. It is also possible that, as shown in FIG. 2B, the one resistor 3 (first resistor) is connected between a connection point D, provided to the anode-side of the diode 4, and a connection point E, provided to the side of the connection terminal 17; and the other resistor 3 (second resistor) is connected between a connection point F, provided to the anode-side of the diode 7, and the connection point E. When using two of the resistors 3 as shown in FIGS. 2A and 2B, the voltage generating circuit 1 is provided with a connecting terminal 18 to be connected with the connection points A and B, and the connecting terminal 18 is connected to a current error amplifying circuit 39 as described later. The current error amplifying circuit 39 is required to be applied with a voltage, according to the magnitude of the current flowing into the resistor 3, as in the case with the connection points C and D. Furthermore, the resistor(s) 3 may be provided external to the voltage generating circuit 1, while the connecting relationship, as described above, is maintained.

The diode 4 includes a function of rectifying the current, and the anode thereof is connected to the other end of the resistor 3, and a cathode thereof is connected to the input-output terminal 12 and the collector of the npn-type transistor 6. In other words, the diode 4 is connected in parallel to the npn-type transistor 6 and the resistor 3 in the reverse direction, and is connected in series to the npn-transistor 2 and the resistor 3 in the forward direction. Resistance value at the resistor 3, configuration of the diode 4, etc. are set in value such that the voltage at cathode-side of the diode 4, when a current flows in the forward directions, becomes at a level lower than that of the saturation voltage of the npn-type transistor 6. Therefore, the current, which is rectified in the diode 4, is supplied to the input-output terminal 12, even if the npn-type transistor 6 is ON when a current flows in the forward direction in the diode 4.

The diode 7 includes a function of rectifying the current, and the anode thereof is connected to the other end of the resistor 3, and a cathode thereof is connected to the input-output terminal 11 and the collector of the npn-type transistor 2. In other words, the diode 7 is connected in parallel to the npn-type transistor 2 and the resistor 3 in the reverse direction, and is connected in series to the npn-transistor 6 and the resistor 3 in the forward direction. Resistance value at the resistor 3, configuration of the diode 7, etc. are set in value such that the voltage at cathode-side of the diode 7, when a current flows in the forward directions, becomes at a level lower than that of the saturation voltage of the npn-type transistor 2. Therefore, the current, which is rectified in the diode 7, is supplied to the input-output terminal 11, even if the npn-type transistor 2 is ON when a current flows in the forward direction in the diode 7.

The output terminal 13 is connected to the first capacitor 33, which is one end of the series capacitor, in order to generate a DC current based on the AC voltage of the AC power supply 30, between both ends of the series capacitor including the capacitor 33 (first capacitor) and the capacitor 34 (second capacitor) which are serially connected between a first output line and a second output line.

The input terminal 14 is connected to the capacitor 34, which is the other end of the series capacitor.

The diode 5 includes a function of rectifying the current, and the anode thereof is connected to the input-output terminal 11, and the cathode thereof is connected to the output terminal 13. In other words, the diode 5 is connected in the forward direction, which is the direction: from the one end of the AC power supply 30 to which the reactor 32 (coil) is connected; to the one end of the series capacitor. The diode 5 is a boost for boosting diode the voltage applied to the one end of the series capacitor, based on the energy charged in the reactor 32.

The diode 8 includes a function of rectifying the current, and the anode thereof is connected to the input terminal 14, and the cathode thereof is connected to the input-output terminal 11. In other words, the diode 8 is connected in the reverse direction, which is the direction: from the one end of the AC power supply 30 to which the reactor 32 is connected; to the other end of the series capacitor. The diode 8 is a boost diode for boosting the voltage applied to the serial connection point of the series capacitor, based on the energy charged in the reactor 32.

### ===The overall configuration of a power supply circuit provided with the voltage generating circuit according to the exemplary embodiment of the present invention ===

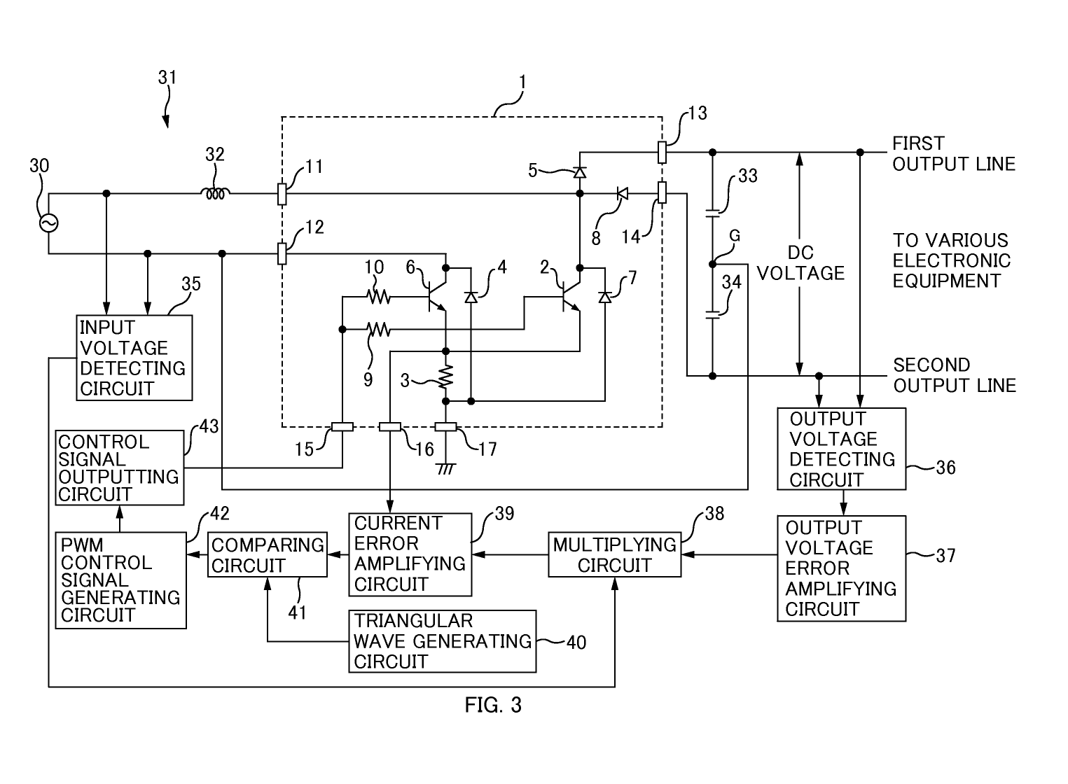

An overall configuration of a power supply circuit 31 provided with the voltage generating circuit 1 according to an embodiment of the present invention will be described hereinafter with reference to FIG. 3. FIG. 3 is a circuit block diagram for showing an example of the overall configuration of the power supply circuit 31 provided with the voltage generating circuit 1.

The power supply circuit 31 includes an input voltage detecting circuit 35, the reactor 32, the voltage generating circuit 1, the capacitors 33 and 34, an output voltage detecting circuit 36, a output-voltage error amplifying circuit 37, a multiplying circuit 38, a current error amplifying circuit 39, a triangular wave generating circuit 40, a comparing circuit 41, a PWM (Phase Width Modulation) control signal generating circuit 42, and a control signal outputting circuit 43. The input voltage detecting circuit 35, the voltage generating circuit 1, the output voltage detecting circuit 36, the output-voltage error amplifying circuit 37, the multiplying circuit 38, the current-error amplifying circuit 39, the triangular wave generating circuit 40, the comparing circuit 41, the PWM control signal generating circuit 42, and the control signal outputting circuit 43 are provided in order to transmit control signals to the above-mentioned npn-type transistors 2 and 6.

The reactor 32 is made up of a toroidal coil, etc., for example, and is connected between the one end of the AC power supply 30 and the input-output terminal 11 of the voltage generating circuit 1. The reactor 32 is charged with energy based on the current flowing from the one end of the AC power supply 30 when the npn-type transistor 2 is ON. The reactor 32 outputs the energy, which is charged when the npn-type transistor 2 is OFF, to the one end of the series capacitor via the diode 5. The reactor 32 is also charged with energy based on the current flowing from the other end of the AC power supply 30 when the npn-type transistor 6 is ON. The reactor 32 also outputs the energy, which is charged when the npn-type transistor 6 is OFF, to the serial connection point of the series capacitor via the AC power supply 30. The reactor 32 may also be connected between the other end of the AC power supply 30 and the input-output terminal 12 of the voltage generating circuit 1. If the reactor 32 is connected to the other end of the AC power supply 30, the npn-type transistor 2 denotes the second transistor, the npn-type transistor 6 denotes the first transistor, the diode 4 denotes the second diode, and the diode 7 should denotes the first diode.

The input voltage detecting circuit 35 is applied with the AC voltage of the AC power supply 30, generates a reference signal with performing a full-wave rectification for the AC voltage, to be output to the multiplying circuit 38.

The capacitors 33 and 34 include, at least, a charge capacity large enough for charging at a maximum AC voltage. The capacitors 33 and 34 are serially connected between the first output line and the second output line. A serial connection point G of the capacitors 33 and 34 is connected to the other end of the AC power supply 30. The capacitor 33 smoothes the current which is flowing out from the one end of the AC power supply 30 when the npn-type transistor 2 is OFF and which is supplied to the capacitor 33 via the diode 5, and is charged with the AC component. The capacitor 34, when the npn-type transistor 6 is OFF: is supplied with the current flowing out from the other end of the AC power supply 30, to be smoothed; and is charged with the AC component thereof. Since each of the charge voltages of the serially connected capacitors 33 and 34 has reached the substantially maximum AC voltage of the AC power supply 30, the DC voltage, which is substantially more than twice the maximum AC voltage, is generated between both ends of the series capacitor made up of the capacitors 33 and 34, due to the charge voltage of the capacitors 33 and 34 and the energy from the reactor 32, to be output to the various electric equipments.

The output voltage detecting circuit 36 divides the DC voltage generated between both ends of the series capacitor, which includes the charge voltage of the capacitors 33 and 34, using a resistor not shown, for example, and outputs the resulting DC voltage to the output voltage error amplifying circuit 37. It becomes possible to adjust the DC voltage to be output to the output voltage error amplifying circuit 37, by setting this resistor not shown at a desired resistance value.

The output voltage error amplifying circuit 37: detects the difference in value between the AC voltage from the output voltage detecting circuit 36 and the predetermined reference voltage; amplifies this difference to obtain an output voltage error amplified signal, to be output to the multiplying circuit 38.

The multiplying circuit 38 multiplies the reference signal from the input voltage detecting circuit 35 by the output voltage error amplified signal from the output voltage error amplifying circuit 37, and outputs the resulting multiplied signal to the current error amplifying circuit 39. This multiplied signal is a signal that is obtained such that the reference signal is changed in amplitude according to the output voltage error amplified signal.

The current error amplifying circuit 39 is connected to a connecting terminal 16 in the voltage generating circuit 1 (in the arrangements shown in FIGS. 2A and 2B, the current error amplifying circuit 39 is also connected to the connecting terminal 18). The current error amplifying circuit 39 generates an actual current signal, which indicates the magnitude of the current flowing through the resistor 3, from the voltage generated according to the resistance value of the resistor 3 and the magnitude of the current flowing through the resistor 3. The current error amplifying circuit 39 then compares the actual current signal with the multiplied signal from the multiplying circuit 38 to detect the difference, amplifies the difference to obtain a current error amplified signal to be output to the comparing circuit 41.

The triangular wave generating circuit 40 generates a triangular wave signal of predetermined amplitude and a predetermined frequency, to be output to the comparing circuit 41.

The comparing circuit 41 compares the current error amplified signal from the current error amplifying circuit 39 with the triangular wave signal from the triangular wave generating circuit 40, and outputs the comparison result to the PWM control signal generating circuit 42.

The PWM control signal generating circuit 42 generates a PWM control signal at a carrier frequency of 20 kHz, for example, based on the comparison result from the comparing circuit 41, to be output to the control signal outputting circuit 43.

The control signal outputting circuit 43 is connected to the connecting terminal 15 in the voltage generating circuit 1. The control signal outputting circuit 43 outputs a control having alternately high level and low level with a repetition frequency higher than that of the AC voltage according to the PWM control signal from the PWM control signal generating circuit 42. According to the present embodiment, it is assumed to be described that the voltage generating circuit 1 is provided only with the connecting terminal 15 for the control signal from the control signal outputting circuit 43, which is output to the gates of the npn-type transistors 2 and 6 via the resistors 9 and 10 in the same manner; however, which is not limitation. For example, separate connecting terminals may also be provided for connecting to the other ends of the resistors 9 and 10 respectively so that the control signal outputting circuit 43 outputs the control signal to each of the connecting terminals. Moreover, according to the present embodiment, it is assumed to be described that the control signal outputting circuit 43 outputs the control signal regardless of the direction in which the AC power supply 30 sends out the current; however, which is not limitation. For example: if the PWM control signal is based on the current flowing out from the one end of the AC power supply 30, then the control signal outputting circuit 43 may send the control signal only to the connecting terminal connected to the other end of the resistor 9; and if the PWM control signal is based on the current flowing out from the other end of the AC power supply 30, then the control signal outputting circuit 43 may send the control signal only to the connecting terminal connected to the other end of the resistor 10.

The voltage generating circuit 1 not only is applied to the power supply circuit 31 including the above configuration (excluding the voltage generating circuit 1), but can be applied to various power supply circuits including different configurations from the one described above.

### ===Paths of currents in the voltage generating circuit according to an embodiment of the present invention and the effects thereof ===

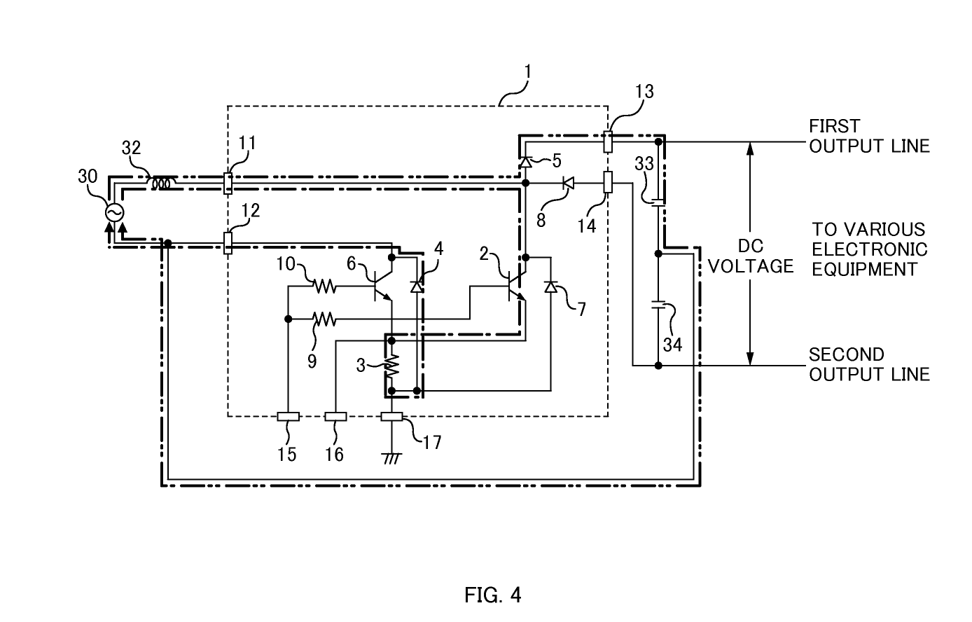

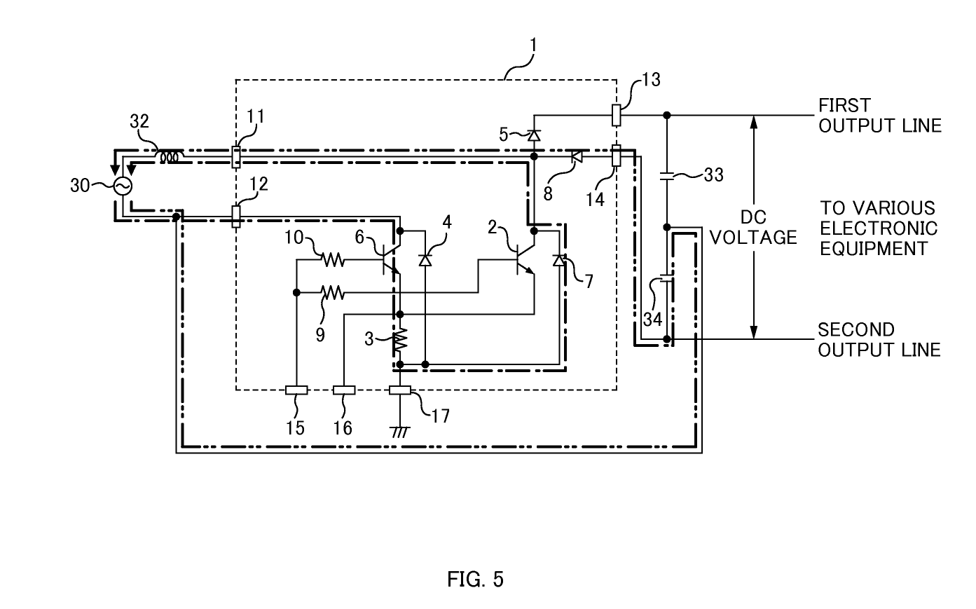

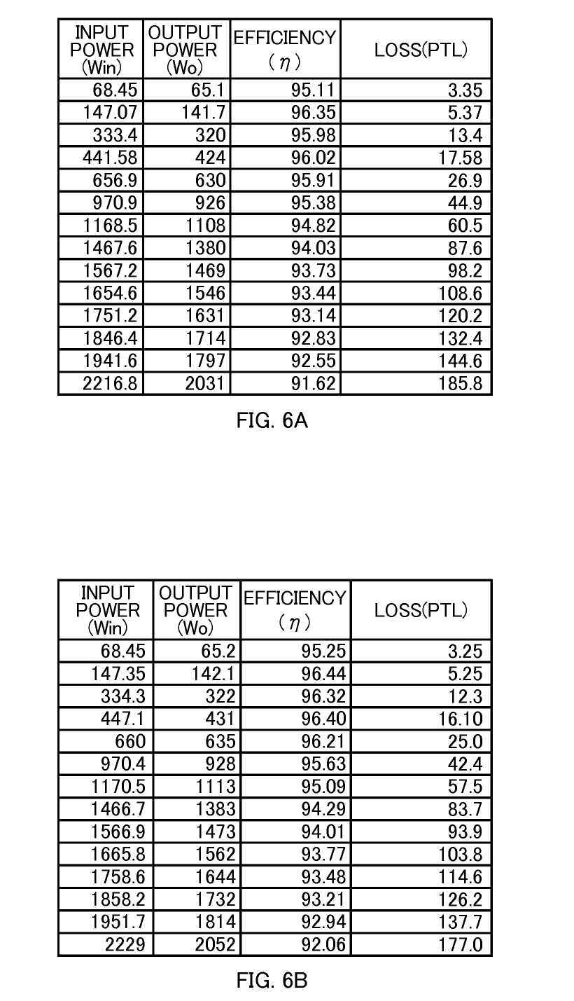

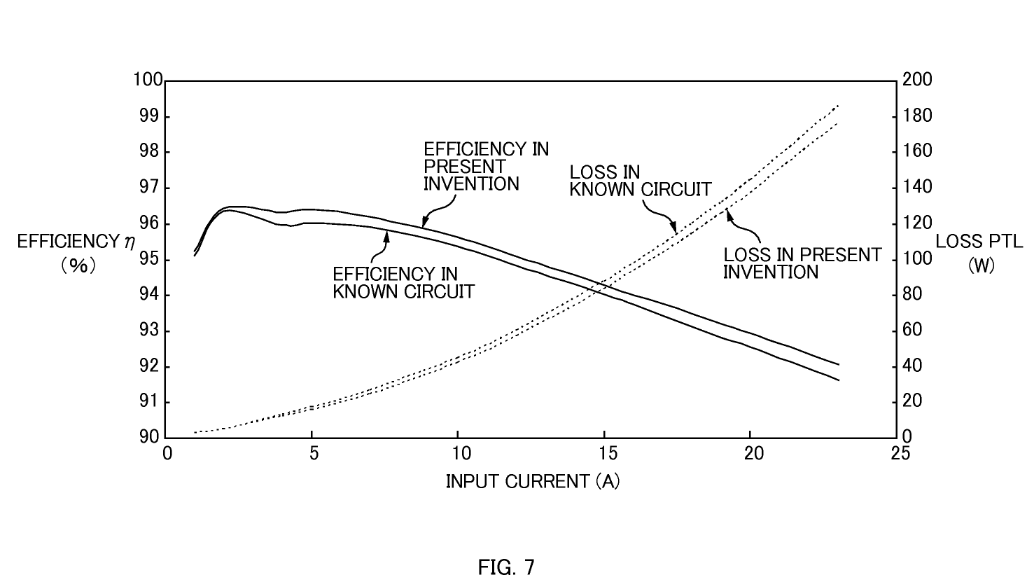

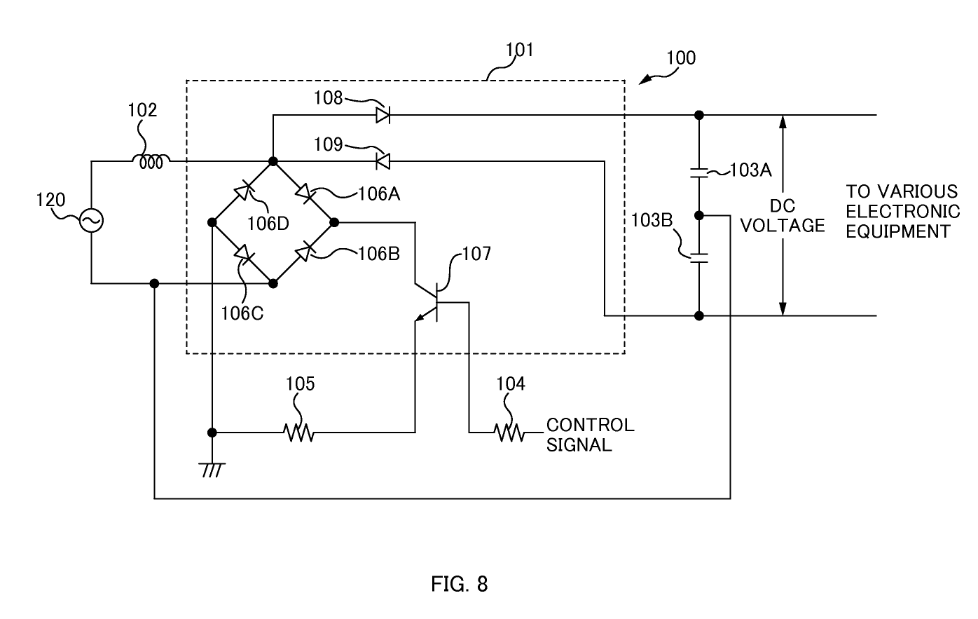

Current paths in the voltage generating circuit 1 according to an embodiment of the present invention, and effects thereof will be described hereinafter with reference to FIGS. 3, 8 to 10, and by using FIGS. 4 to 7. FIG. 4 is a diagram showing a path of a current that flows out from the one end of the AC power supply 30 in the voltage generating circuit 1 according to an embodiment of the present invention. FIG. 5 is a diagram showing a path of a current that flows out from the other end of the AC power supply 30 in the voltage generating circuit 1 according to an embodiment of the present invention. FIG. 6A is a table showing the efficiency (η)(=output power (Wout)/input power(Win)×100) and loss (PTL)(=input power (Win)−output power (Wout)) of the output power (Wout) with respect to the input power (Win) in the voltage generating circuit 101 shown in FIGS. 8 to 10. FIG. 6B is a table showing efficiency (η) and loss (PTL) of the output power (Wout) with respect to the input power (Win) in the voltage generating circuit 1 according to an embodiment of the present invention. FIG. 7 is a plot showing the efficiency (η) and the loss (PTL) shown in FIGS. 6A and 6B.

### <<Case where Current Flows Out from the One End of the AC Power Supply 30 and the Npn-Type Transistor 2 is ON>>

Since the potential at the one end of the AC power supply 30, which is connected to the reactor 30, becomes higher than that at the other end thereof, the current flows out from the one end of the AC power supply 30 to the voltage generating circuit 1 via the reactor 32. At this time, when the control signal outputting circuit 43 outputs a high-level control signal, which is based on the PWM control signal from the PWM control signal generating circuit 42, to the voltage generating circuit 1, the npn-transistor 2 is turned ON based on the high-level control signal to be input via the resistor 9.

As a result, the current from the one end of the AC power supply 30 flows into the other end thereof along the path shown with a single-dotted line in FIG. 4, through the one end of the AC power supply 30, the reactor 32, the input-output terminal 11, the npn-type transistor 2, the resistor 3, the diode 4 and the input-output terminal 12. At this time, the current flowing out from the one end of the AC power supply 30 is rectified by the rectifying function of the diodes 4, and the reactor 32 is charged with the energy based on the current flowing out from the one end of the AC power supply 30. In this manner, in the voltage generating circuit 1, when the npn-type transistor 2 is ON, the current from one end of the AC power supply 30 flows through two circuit elements that are the npn-type transistor 2 and the diode 4. Therefore, the power is consumed by these two circuit elements (npn-type transistor 2 and diode 4) that the current flows through.

### <<Case where Current Flows Out from the One End of the AC Power Supply 30 and the Npn-Type Transistor 2 is OFF>>

In the case that the current flows out from the one end of the AC power supply 30, when the control signal outputting circuit 43 outputs a low-level control signal, which is based on the PWM control signal from the PWM control signal generating circuit 42, to the voltage generating circuit 1, the npn-transistor 2 is turned OFF based on the low-level control signal to be input via the resistor 9.

As a result, the current from the one end of the AC power supply 30 flows into the other end thereof along the path shown with a double-dotted line in FIG. 4, through the one end of the AC power supply 30, the reactor 32, the input-output terminal 11, the diode 5, the output terminal 13, and the capacitor 33. At this time, the current flowing out from the one end of the AC power supply 30 is rectified by the rectifying function of the diodes 5, and the capacitor 33 is charged with the AC component of this current. Furthermore, the energy charged in the reactor 32 is supplied to the one end of the series capacitor. In this manner, in the voltage generating circuit 1, when the npn-type transistor 2 is OFF, the current from the one end of the AC power supply 30 flows through one circuit element that is the diode 5. Therefore, the power is consumed by this one circuit element (diode 5) that the current flows through.

### <<Case where Current Flows Out from the Other End of the AC Power Supply 30 and the Npn-Type Transistor 6 is ON>>

Since the potential at the other end of the AC power supply 30 becomes higher than that at the one end thereof, the current from the other end of the AC power supply 30 flows into the voltage generating circuit 1. At this time, when the control signal outputting circuit 43 outputs a high-level control signal, which is based on the PWM control signal from the PWM control signal generating circuit 42 to the voltage generating circuit 1, the npn-transistor 6 is turned ON based on the high-level control signal to be input via the resistor 10.

As a result, the current flows from the other end of the AC power supply 30 into the one of the AC power supply 30, along the path shown with a single-dotted line in FIG. 5, through the other end of the AC power supply 30, the input-output terminal 12, the npn-type transistor 6, the resistor 3, the diode 7, the input-output terminal 11, and the reactor 32. At this time, the current flowing out from the other end of the AC power supply 30 is rectified by the rectifying function of the diodes 7, and the reactor 32 is charged with the energy based on the current flowing out from the other end of the AC power supply 30. In the voltage generating circuit 1, when the npn-type transistor 6 is ON, the current from one end of the AC power supply 30 flows through two circuit elements that are the npn-type transistor 6 and the diode 7. Therefore, the power is consumed by these two circuit elements (npn-type transistor 6 and diode 7) that the current flows through.

### <<Case where Current Flows Out from the Other End of the AC Power Supply 30 and the Npn-Type Transistor 6 is OFF>>

In the case that the current flows out from the other end of the AC power supply 30, when the control signal outputting circuit 43 outputs a low-level control signal, which is based on the PWM control signal from the PWM control signal generating circuit 42, to the voltage generating circuit 1, the npn-transistor 6 is turned OFF based on the low-level control signal to be input via the resistor 10.

As a result, the current flows from the other end of the AC power supply 30 into the one end thereof along the path shown with a double-dotted line in FIG. 5, through the other end of the AC power supply 30, the capacitor 34, the input terminal 14, the diode 8, the input-output terminal 11 and the reactor 32. At this time, the current flowing out from the other end of the AC power supply 30 is rectified by the rectifying function of the diodes 8, and the capacitor 34 is charged with the AC component of this current. Furthermore, the energy charged in the reactor 32 is supplied to the series connection point G of the series capacitor. In the voltage generating circuit 1, when the npn-type transistor 6 is OFF, the current from the other end of the AC power supply 30 flows through one element that is the diode 8. Therefore, the power is consumed by this one circuit element (diode 8) that the current flows through.

### <Effects of Voltage Generating Circuit 1>

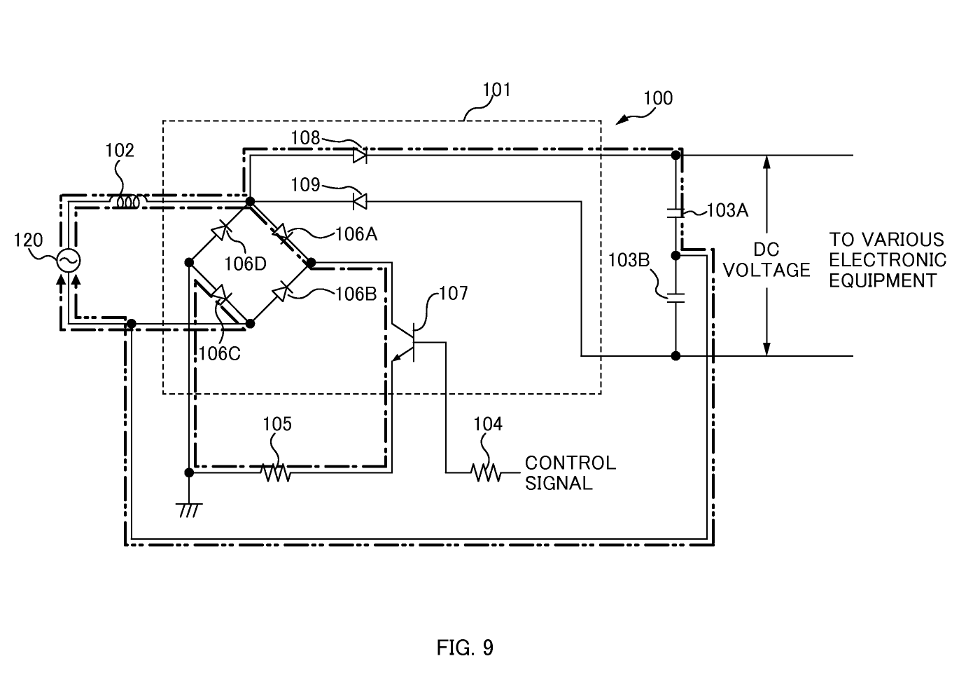

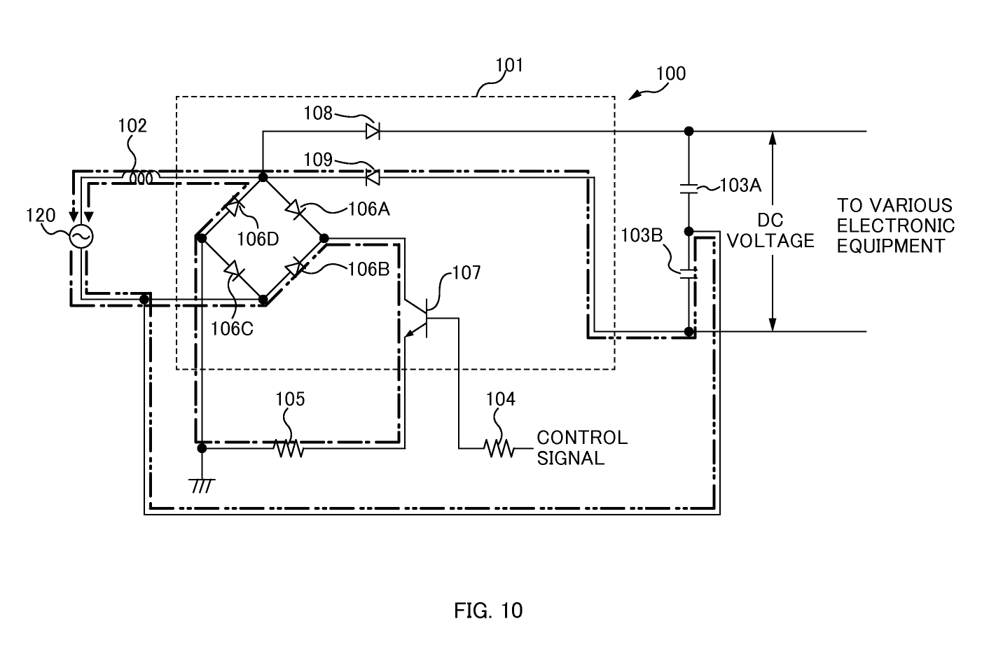

To begin with, the efficiency (η) and loss (PTL) of the output voltage (Wout) with respect to the input power (Win) in the voltage generating circuit 101 will be described hereinafter with reference to FIGS. 8 to 10. In the voltage generating circuit 101, when the current flows out from the one end of the AC power supply 120, if the npn-type transistor 107 is ON (single-dotted line in FIG. 9), the power is consumed due to three circuit elements (diodes 106A and 106C, and npn-type transistor 107). When the current flows out from the one end of the AC power supply 120 if the npn-type transistor 107 is OFF (double-dotted line in FIG. 9), the power is consumed due to one circuit element (diode 108). In the voltage generating circuit, when the current flows out from the other end of the AC power supply 120, if the npn-type transistor 107 is ON (single-dotted line in FIG. 10), the power is consumed due to three circuit elements (diodes 106B and 106D, and npn-type transistor 107). When the current flows out from the other end of the AC power supply 120, if the npn-type transistor 107 is OFF (double-dotted line in FIG. 10), the power is consumed due to one circuit element (diode 109). In other words, in the power supply circuit 100 including the voltage generating circuit 101, when outputting a DC voltage based on the AC voltage of the AC power supply 120, the power is consumed due to eight circuit elements. The efficiency (η) and loss (PTL) of the output power (Wout) with respect to the input power (Win) are shown in FIG. 6A. For example, the output power (Wout) for the input power 1467.6 (W) is 1380 (W) since the power is consumed due to these eight circuit elements. The efficiency (η) is 94.03(%) and the loss (PTL) is 87.6 (W).

On the other hand, in the voltage generating circuit 1, when the current flows out from the one end of the AC power supply 30, if the npn-type transistor 2 is ON (single-dotted line in FIG. 4), the power is consumed due to two circuit elements (npn-type transistor 2 and diode 4). When the current flows out from the one end of the AC power supply 30, if the npn-type transistor 2 is OFF (double-dotted line in FIG. 4), the power is consumed due to one circuit element (diode 5). In the voltage generating circuit 1, when the current flows out from the other end of the AC power supply 30, if the npn-type transistor 6 is ON (single-dotted line in FIG. 5), the power is consumed due to two circuit elements (npn-type transistor 6 and diode 7). When the current flows out from the other end of the AC power supply 30, if the npn-type transistor 6 is OFF (double-dotted line in FIG. 5), the power is consumed due to one circuit element (diode 8). In other words, in the power supply circuit 31 including the voltage generating circuit 1, when outputting a DC voltage based on the AC voltage from the AC power supply 30, the power is consumed due to six circuit elements. That is, the power consumption caused by two circuit elements is reduced in the voltage generating circuit 1, as compared with the voltage generating circuit 101. In the power supply circuit 31, the efficiency (I) and loss (PTL) of the output power (Wout) with respect to the input power (Win) are shown in FIG. 6B. For example, the output voltage (Wout) for the input voltage 1466.7 (W), which is approximately the same as the input power 1467.6 (W) of the above case, is 1383 (W) since the power is consumed by these six circuit elements, where the efficiency (I) is 94.29(%), and the loss (PTL) is 83.7 (W).

In other words, the voltage generating circuit 1 is capable of reducing the number of circuit elements on the path where the current flows, as compared with the voltage generating circuit 101. As a result, it is clear from FIG. 7, which is a plot of the data of FIGS. 6A and 6B, that the efficiency (η) of the output voltage (Wout) with respect to the input power (Win) can be improved, and the loss (PTL) thereof can be reduced. In other words, since the voltage generating circuit 1 includes the configuration described above, the power factor thereof is improved, as compared with the voltage generating circuit 101.

According to an embodiment described above, when the npn-type transistor 2 is ON, the current from the one end of the AC voltage 30 flows through two circuit elements (npn-type transistor 2 and diode 4) into the other end of the AC voltage 30. When the npn-type transistor 2 is OFF, the current from the one end of the AC voltage 30 flows through one circuit element (diode 5) into the other end of the AC voltage 30. When the npn-type transistor 6 is ON, the current from the other end of the AC voltage 30 flows through two circuit elements (npn-type transistor 6 and diode 7) to the one end of the AC voltage 30. When the npn-type transistor 6 is OFF, the current from the other end of the AC voltage 30 flows through one circuit element (diode 8) into the one end of the AC voltage 30. As a result, the power consumption by the circuit elements can be reduced, as compared with a voltage generating circuit including seven or more circuit elements (eight elements in the voltage generating circuit 101 shown in FIGS. 8 to 10) that the current flows through, when generating a DC voltage at both ends of the series capacitor based on the AC voltage supplied from the AC power supply 30, so that the generation efficiency (so-called power factor) of the DC voltage with respect to the AC voltage can be improved. Since the circuit elements are reduced in number, it is also possible to reduce the cost in connection with the voltage generating circuit 1 or the size thereof.

Furthermore, the current flowing through the capacitors 33 and 34 can be controlled by controlling the npn-type transistors 2 and 6 as to ON and OFF based on the magnitude of the current flowing through each of the npn-type transistors. As a result, it is possible to control the current flowing in the voltage generating circuit 1 so as to be analogous in waveform to a sine-wave AC voltage, so that the harmonics are suppressed and the power factor is improved.

Furthermore, in order to control ON and OFF of the npn-type transistors 2 and 6, there can be detected: the current flowing out from the one end of the AC power supply 30 when the npn-type transistor 2 is ON; and the current flowing out from the other end of the AC power supply 30 when the npn-type transistor 6 is ON, at the resistor 3 included in the voltage generating circuit 1. Furthermore, since the resistor 3 is commonly connected serially to the npn-type transistor 2 and the diode 4, and to the npn-type transistor 6 and the diode 7, the voltage generating circuit 1 can be reduced in cost and size, as compared with the voltage generating circuit including separate resistors for detecting the currents flowing out from the one end and the currents flowing out from the other end of the AC power supply 30, respectively.

Furthermore, by using a common signal line to transmit the control signals for controlling ON/OFF of the npn-type transistor 2 and 6, the cost or size of the voltage generating circuit 1 can be reduced on the integration thereof due to the reduction of the number of the connecting terminals etc., as compared with the case that the voltage generating circuit is provided with respective signal lines for transmitting control signals to the npn-type transistors 2 and 6. Furthermore, it is also possible to simplify an algorithm or a configuration, etc. of the external circuits used for transmitting the control signals.

If the voltage generating circuit 1 is provided with two of the resistors 3 as shown in FIGS. 2A and 2B, the two resistor 3 may be used to detect the current flowing out from the one end of the AC power supply 30 when the npn-type transistor 2 is ON in order to control ON/OFF of the npn-type transistor 2, and to detect the current flowing out from the other end of the AC power supply 30 when the npn-type transistor 6 is ON in order to control ON/OFF of the npn-type transistor 6.

The above embodiments of the present invention are simply for facilitating the understanding of the present invention and are not in any way to be construed as limiting the present invention. The present invention may variously be changed or altered without departing from its spirit and encompass equivalents thereof.

What is claimed is:

1. A voltage generating circuit for generating a DC voltage at both ends of a series capacitor based on an AC voltage generated from an AC power supply with one end thereof connected to a coil, the series capacitor including a first capacitor and a second capacitor with a series connecting point thereof connected to the other end of the AC power supply, the voltage generating circuit comprising:
a first transistor connected to the one end of the AC power supply via the coil;
a second transistor connected to the other end of the AC power supply;
a first diode connected in parallel to the second transistor in a reverse direction, and in series to the first transistor in a forward direction;
a second diode connected in parallel to the first transistor in a reverse direction, and in series to the second transistor in a forward direction;
a third diode connected between the one end of the AC power supply via the coil and one end of the series capacitor, in a forward direction from the AC power supply to the one end of the series capacitor; and
a fourth diode connected between the one end of the AC power supply via the coil and the other end of the series capacitor, in a reverse direction from the AC power supply to the other end of the series capacitor,
a current from the one end of the AC power supply flowing through the coil, the first transistor and the first diode into the other end of the AC power supply when the first transistor is ON, and the current flowing through the coil, the third diode and the first capacitor into the other end of the AC power supply when the first transistor is OFF; and
a current from the other end of the AC power supply flowing through the second transistor, the second diode and the coil into the one end of the AC power supply when the second transistor is ON, and the current flowing through the second capacitor, the fourth diode and the coil into the one end of the AC power supply when the second transistor is OFF.

2. The voltage generating circuit of claim 1, wherein
the first transistor and the second transistor are controlled as to ON and OFF based on a magnitude of a current flowing through each of the first transistor and the second transistor.

3. The voltage generating circuit of claim 2 further comprising:
a first resistor connected in series to the first transistor and the first diode to detect the current flowing out from the one end of the AC power supply when the first transistor is ON; and
a second resistor connected in series to the second transistor and the second diode to detect the current flowing out from the other end of the AC power supply when the second transistor is ON, wherein
the first transistor and the second transistor are controlled as to ON and OFF based on a magnitude of the current detected at the first resistor and the second resistor.

4. The voltage generating circuit of claim 2, further comprising:
a resistor commonly connected in series to the first transistor and the first diode, and to the second transistor and the second diode, to detect the current flowing out from the one end of the AC power supply when the first transistor is ON and to detect the current flowing out from the other end of the AC power supply when the second transistor is ON, wherein
the first transistor and the second transistor are controlled as to ON and OFF based on a magnitude of the current detected at the resistor.

5. The voltage generating circuit of claim 2, wherein
the first transistor and the second transistor are controlled as to ON and OFF by a control signal based on the magnitude of the current, which is transmitted via a common signal line.
